(19) United States
(12) Patent Application Publication
(10) Pub. No.: US 2008/0101218 A1
(43) Pub. Date: May 1, 2008

(54) METHOD AND DEVICE FOR IMPLEMENTING ACTIVE/STANDBY GATEWAY DEVICE IN A NETWORK

(76) Inventor: Wenyang Lei, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/962,283

(22) Filed: Dec. 21, 2007

Related U.S. Application Data
(63) Continuation of application No. PCT/CN2006/001363, filed on Jun. 16, 2006.

(30) Foreign Application Priority Data
Jun. 23, 2005 (CN) 200510077395.6

(51) Int. Cl. H04J 3/14; H04L 12/56

(52) U.S. Cl. 370/219; 370/401

(57) ABSTRACT

A method and device for implementing active and standby gateway devices in a network are provided. The method includes: determining, by a device connected to at least two gateway devices, status of the gateway devices; notifying, by the device, the gateway devices of information of determined active or standby status; implementing corresponding processing functions by the gateway devices according to the information of determined active or standby status sent from the device. With the invention, the switchover speed between active and standby gateway devices may be faster, the switchover time required may be reduced to 50 ms, from 3 s. Two gateway devices are impossible to become active gateway at the same time in the invention, thereby an error switchover between active and standby gateway devices may be avoided, the switchover may be more accurate and reliable.

This application is a Continuation Application of PCT/CN2006/001363 submitted on Jun. 26, 2006, claiming the priority from a Chinese patent application No. 200510077395.6 submitted on Jun. 23, 2005, the contents of which are incorporated herein by reference.

### FIELD OF THE INVENTION

The invention relates to the field of network communications, and in particular, to a method and device for implementing active and standby gateway devices in a network.

### BACKGROUND OF THE INVENTION

With the development of Internet technologies, a large number of hosts (a host may be a computer, or any other device) are required to connect to Internet, to be served by other hosts or to provide services to other hosts.

A gateway device is necessary for connecting a host to Internet. A fault appearing in the Gateway device may result in a communication interrupt between the host and Internet. In such a situation, the host can not be served by other devices over Internet, and is incapable of providing services to other devices over Internet.

Some important hosts each are required to connect to two or more gateway devices at the same time, so as to prevent the communication interrupt between the hosts and Internet due to faults in the gateway devices. As shown in FIG. 1, a gateway device 221 is used as an active gateway to provide connection service to a host 210, and a gateway device 222 is used as a standby gateway. When a fault occurs in the active gateway, the standby gateway takes over to provide services to the host 210. In this way, the communication interrupt between the host 210 and Internet 230 due to a fault in a gateway device may be avoided efficiently.

Generally, Virtual Router Redundancy Protocol (VRRP) is utilized to implement a redundancy backup between a host and two gateways. FIG. 2 illustrates a particular method, which is as follows:

Two interfaces 211 and 212 are provided in the host 210 for connections to two gateway devices 221 and 222. The interface 211 is an active interface and the interface 212 is a standby interface. In normal conditions, only one interface 211 (active interface) is capable of the reception and transmission of data packets, while the other interface 212 (standby interface) which is in standby status can not receive and transmit data packets. When one interface has a fault, the other interface is activated.

In a VRRP-based solution, VRRP runs over the two gateway devices, a virtual Internet Protocol (IP) address is provided. The address of the gateway devices known by the host 210 is a virtual IP address. As shown in FIG. 2, the common virtual IP address of the gateway devices 221 and 222 is 10.100.10.1. Each of the two gateways has a physical IP address. In FIG. 2, the physical IP address of the gateway device 221 is 10.100.10.2, and the physical IP address of the gateway device 222 is 10.100.10.3. The virtual IP address is a service address of the gateway device.

During startup, information is exchanged between the two gateway devices 221 and 222, to determine which is the active or standby gateway. In normal operation, timed status synchronization is required between the two gateway devices 221 and 222. The standby gateway determines whether the active gateway is working normally according to synchronization information. If the standby gateway does not receive synchronization messages from the active gateway, the standby gateway determines that the active gateway has a fault and takes over, i.e. the standby gateway becomes the active gateway.

In the above solution, faults of the active and standby gateways are detected in accordance with a heartbeat protocol of VRRP. The time period of the heartbeat protocol is 1 second. Usually a fault can not be determined before the detection has been performed three times. Therefore, it takes a relatively long time, i.e. usually more than 3 seconds, to detect a fault.

Furthermore, VRRP does not allow the two gateway devices 221 and 222 to be in active status at the same time. The situation that the two gateway devices serve as active gateways at the same time may result in uncontrollable errors. As shown in FIG. 3, for example, if the connection between the active and standby gateways is interrupted while no fault occurs in both of the two gateway devices 221 and 222, each of the gateway devices 221 and 222 enters active status, and publishes a route associated with the host 210 onto Internet 230. In this way, a packet destined for the host 210 from a router on Internet may be sent to the gateway devices 221, or may be sent to the gateway devices 222. However, because only one of the two interfaces in the host 210 is the active interface connected to the gateway while the other interface can not receive and transmit packets, the gateway device connected to the other interface can not send received packets from Internet to the host 210. As a result, the host can not be served by Internet normally.

### SUMMARY OF THE INVENTION

Embodiments of the invention provide a method and device for implementing active and standby gateway devices in a network, to avoid an error switchover between the active and standby gateways, and improve the switchover speed efficiently.

A method for implementing active and standby gateway devices in a network includes:
determining, by a host connected to a plurality of gateway devices, status of the gateway devices; notifying, by the host, the gateway devices of information of determined active or standby status; and implementing corresponding processing functions by the gateway devices according to the information of determined active or standby status sent from the host.

According to another aspect of the invention, an apparatus for processing status of a gateway device is provided. The apparatus is configured in a host, and includes:
a status determination unit, adapted for determining an active or standby status of an interface via which the host is connected to the gateway device; and a status notification unit, adapted for notifying the gateway device, connected to the host, of the determined active or standby status of the interface.

According to a further aspect of the invention, a gateway device is provided. The gateway device includes:
a status notification receiving unit, adapted for receiving active or standby status information of an interface from a host; and a status adjustment unit, adapted for setting the gateway device into a status corresponding to the active or standby status information of the interface.

As can be seen, in the above technical solutions, the switchover speed between active and standby gateway devices is relatively fast. In other words, the switchover in the invention is faster than that in the prior art. The switchover time required may be reduced to 50 milliseconds, compared with the 3 seconds required in the prior art.

Furthermore, the switchover speed between active and standby gateway devices is controlled by a host in the invention, without any need of running heartbeat protocol between the active and standby gateway devices, and thereby the possibility that two gateway devices become active gateways at the same time may be avoided. As a result, an error switchover between the active and standby gateway devices may be avoided, and thereby the switchover may be not only faster, but also more accurate and reliable.

### BRIEF DESCRIPTION OF THE DRAWINGS

FIG. 1 is a diagram illustrating the structure of a network including an active gateway and a standby gateway in the prior art;

FIG. 2 is a diagram illustrating a switchover process between an active gateway and a standby gateway in the prior art;

FIG. 3 is a diagram illustrating an error switchover process between an active gateway and a standby gateway in the prior art;

FIG. 4 is a flow chart illustrating a method according to an embodiment of the invention;

FIG. 5 is a diagram illustrating a switchover process between an active gateway and a standby gateway according to an embodiment of the invention;

FIG. 6 is a diagram illustrating a switchover process when a interface fault occurs between an active gateway and a standby gateway according to an embodiment of the invention.

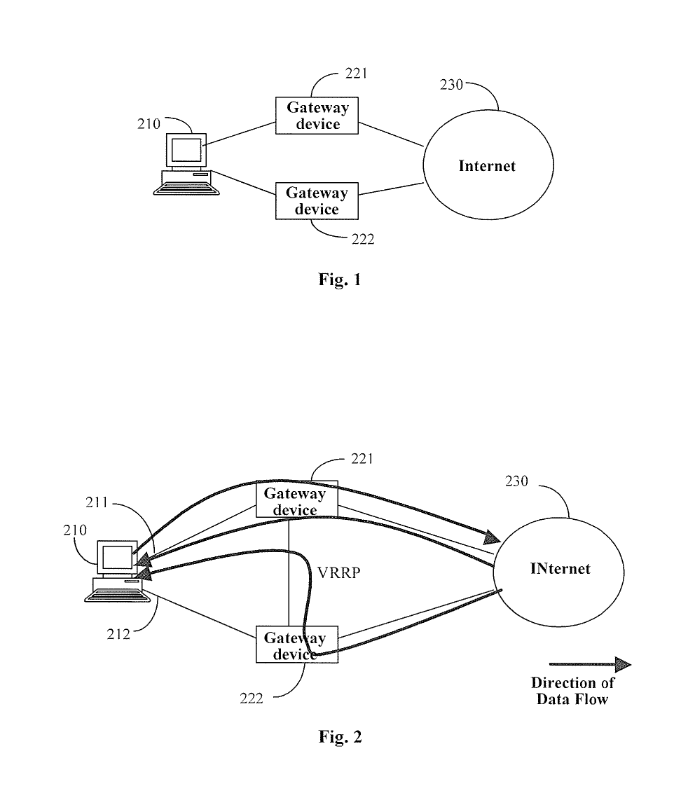

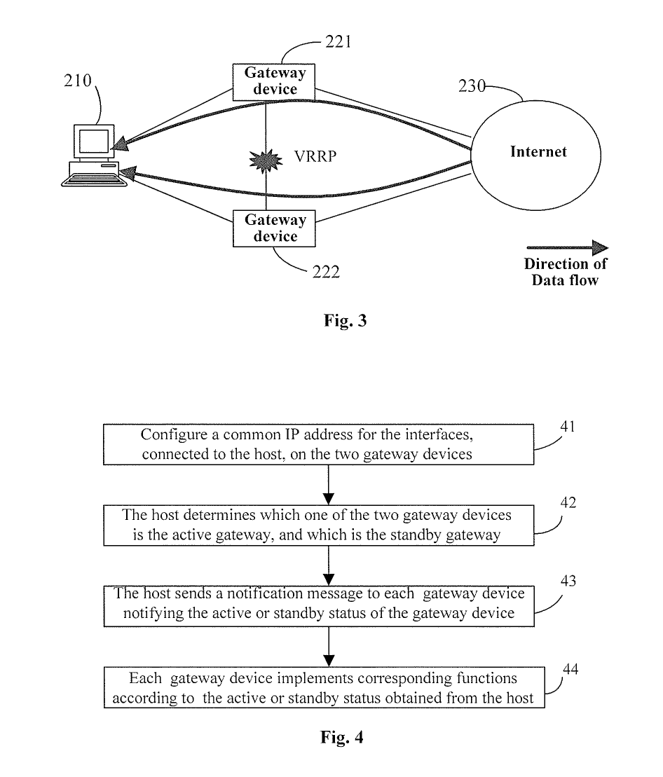

### DETAILED DESCRIPTION OF THE EMBODIMENTS

In the embodiments of the invention, a host determines whether two gateway devices connected to the host should be in an active or standby status, and notifies the gateway devices of information of the determined active or standby status of the gateway devices. Each of the two gateway devices determines its own status, i.e. the active or standby status, according to the information notified by the host, and processes accordingly. With the invention, the two gateway devices may switch between the active and standby status without the need of running any heartbeat protocol between the two gateway devices.

Furthermore, in the embodiments of the invention, a corresponding route priority may be configured for each of the active and standby gateway devices, and route information with the priority information may be propagated. In this way, the active or standby gateway device may be chosen according to the route priorities in the communication network, so as to implement switchover between the active and standby gateway devices.

Particularly, a notification message notifying the active or standby status of interfaces is transmitted between a host and gateway devices. Each of the gateway devices determines the active or standby status of interfaces according to the notification message from the host, to determine the route priorities of interfaces connected to the host. The route priority of a standby interface is lower than priorities of other routes. When publishing a route of an interface connected to the host, the gateway device determines the priority of the route according to the status of the interface. If the status of the interface is active, the route to be published has a higher priority. If the status of the interface is standby, the route to be published has a lower priority. As a result, a proper active gateway device may be chosen for a packet destined for the host from a router on Internet.

A method according to an embodiment of the invention is described in detail below in conjunction with the drawings.

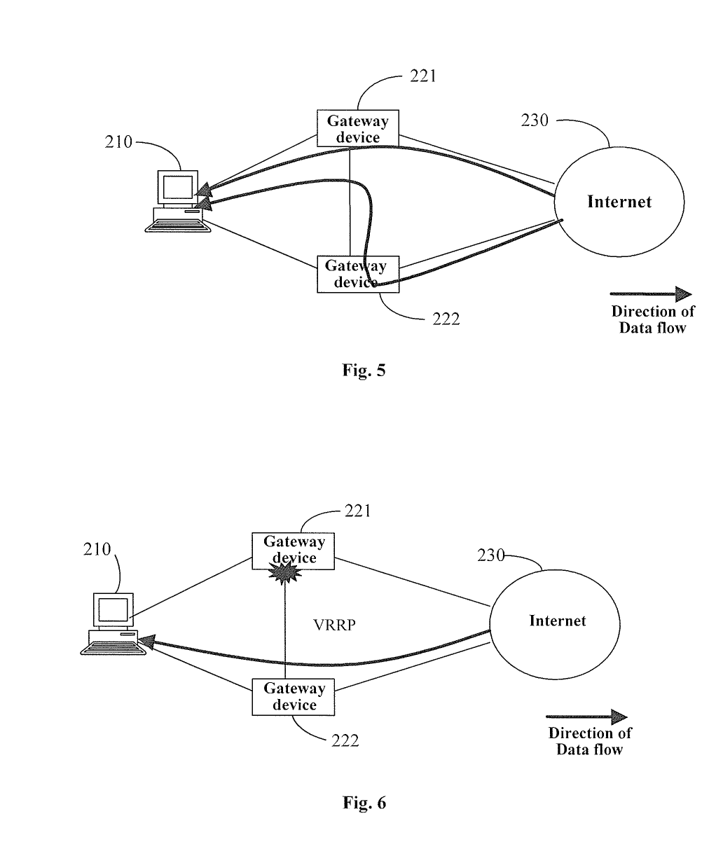

FIGS. 4 and 5 illustrate a process for implementing the method according to the embodiment of the invention, which is as follows:

In block 41, interfaces, connected to a host, on two gateway devices are configured with a common IP address.

As shown in FIG. 5, the interfaces, connected to the host, on a gateway device 221 and a gateway device 222 have a common IP address, i.e. 10.100.10.1.

In block 42, the host chooses one gateway device as an active gateway, and the other gateway device as a standby gateway. In other words, the host chooses one interface of two interfaces, connected to the gateway devices, on the host as an active interface, and the other interface as a standby interface.

When both the two gateway devices are normal, the host chooses any one of the two gateway devices as the active gateway. When one of the two gateway devices has a fault, the host chooses the other one of the two gateway devices as the active gateway.

In block 43, the host sends a notification message via interfaces connected to the gateway devices, notifying whether the interfaces are active interface or standby interface.

For example, when discovering that the active interface has a fault, the host sends a notification message notifying the gateway device connected to the standby interface, and changes the status of the standby interface so that the standby interface becomes the active, to assure, thereby, that one, and only one, interface serves as an active interface at a time.

The notification message may be directly encapsulated over a link layer protocol, or may be carried over IP layer, and should not be limited to a particular form.

The format of the active/standby interface information carried in the notification message may be a field having one and only one bit. The value 1 of the bit indicates that the interface is an active interface, and the value 0 f the bit represents that the interface is a standby interface, and vice versa.

The interface information may be in other formats.

In block 44, the gateway devices receive the notification messages sent from the host, and determine whether the interfaces, via which the gateway devices are connected to the host, are an active interface or a standby interface, to implement corresponding functions, i.e. the functions to be implemented by each of the active and standby gateway devices.

When the active or standby status of each of the gateway devices is determined, the gateway devices adopt different route publishing policies and message forwarding policies according to their status.

(1) Route Publishing Policy

In addition, when the two gateway devices are determined to be an active or standby gateway, each of the two gateway devices publishes a route of an interface connected to the host according to its active or standby status. If the interface is an active interface, the priority of the published route is relatively higher; otherwise, the priority of the published route is relatively lower. Of course, the standby gateway device may not publish a route of an interface connected to the host.

Packets destined for the host sent from a router on Internet is transmitted preferentially by the active gateway device connected to the active interface, because the route priority of the active gateway device is higher.

(2) Message Forwarding Policy

The active gateway device is adapted to directly send a message, from the network, to the host. When receiving a message destined for the host from the network, the standby gateway device forwards the message to the active gateway device, and the active gateway device transmits the message to the host.

As shown in FIG. 5, one gateway device, i.e. any one of two gateway devices 221 and 222, is connected to the host via two routes. One of the two routes is a direct route, i.e., a route directly connected to the host, the egress of which is an interface connected to the host. The other of the two routes is an indirect route via which the one gateway device is connected to the other gateway device. The egress of the indirect route is an interface connected to the other gateway device. The one gateway device may also be connected to the other gateway device via other routers.

Usually, a router (a gateway device is also a router) considers the priority of a direct route to be higher than that of an indirect route. In addition, in an embodiment of the invention, the route of an interface has a lower priority than other routes if the interface is a standby interface. Therefore, normally a packet destined for the host is sent from the network directly to the active gateway device, which forwards the packet to the host. However, when a path between the network and the active gateway device has a fault, the network may send a packet destined for the host to the standby gateway device. When receiving the packet destined for the host from, for example, Internet, the standby gateway device forwards the packet to the other gateway device, i.e. the active gateway device, and the active gateway device forwards the packet to the host.

A process after a fault occurs in an active gateway device is described below in conjunction with the drawings.

As shown in FIG. 5, currently the gateway device 221 is in active status. Once the gateway device 221 has a fault, the host 210 notifies the gateway device 222 to change the status of an interface, connected to the host 210, on the gateway device 222 into active status. In addition, the host 210 configures an interface connected to the gateway device 221 to be in standby status. Upon recovery from the fault, the gateway device 221 will know from the host 210 that its interface connected to the host 210 is currently in standby status.

FIG. 6 shows the data flow after the switchover between the active and standby gateways. The data destined for the host sent from the network are transmitted to the host 210 directly via the current active gateway device, i.e., the gateway device 222.

In the invention, the switchover speed between active and standby gateway devices depends on the time for detecting an interface fault between a host and a gateway device. Usually it takes different time for detecting different interfaces. For some interfaces, the interface fault detection time may be within 50 milliseconds. In general, the interface fault detection time is shorter than the time taken by heartbeat protocol to detect a gateway fault. Therefore, a switchover between active and standby gateway devices may be completed within 50 milliseconds at the soonest in the invention, which is much speedier than that in VRRP.

In summary, the time for switchover between an active gateway device and a standby gateway device may be reduced to 50 milliseconds in the invention, compared with the 3 seconds in the prior art. Furthermore, switchover between active and standby gateway devices is controlled by a host, without any need of running heartbeat protocol between the two gateway devices. As a result, the two gateway devices are impossible to become active gateways at the same time. In this way, the switchover protection of the gateway devices may be more accurate and reliable.

An apparatus for processing status of a gateway device according to the invention is configured in a host. The apparatus includes:

a status determination unit, adapted to determine active or standby status of an interface via which the host is connected to the gateway device;

a status notification unit, adapted to notify the gateway device, connected to the host, of the determined active or standby status of the interface.

Optionally, the apparatus may further include an interface detection unit, adapted to detect working status of the interface via which the host is connected to the gateway device, and provide a result of the detection to the status determination unit.

Optionally, the apparatus may further include a packet construction unit, adapted to construct a notification message required by the status notification unit to notify the active or standby status of the interface.

A gateway device according to the invention includes:

a status notification receiving unit, adapted to receive active or standby status information of an interface from a host;

a status adjustment unit, adapted to set the gateway device into status corresponding to the active or standby status information of the interface.

Though some preferred embodiments of the invention have been described above, the protection scope of the invention is not intended to be limited to these. Any modifications and substitutions readily recognized by those skilled in the art within the scope of the invention shall be covered within the protection scope of the invention, which shall be defined by the following claims.

What is claimed is:

1. A method for implementing active and standby gateway devices in a network, comprising:
determining, by a device connected to at least two gateway devices, status of the gateway devices;
notifying, by the device, the gateway devices of information of determined active or standby status; and
implementing corresponding processing functions by the gateway devices according to the information of determined active or standby status sent from the device.

2. The method according to claim 1, wherein determining by the device status of the gateway devices comprises:
when the at least two gateway devices are normal, choosing, by the device, one of the gateway devices as an active gateway device, and others of the gateway devices as standby gateway devices.

3. The method according to claim 1, wherein notifying by the device the gateway devices of information of determined active or standby status comprises:
transmitting, by the device, information of active or standby status to each of the gateway devices respectively.

4. The method according to claim 1, wherein notifying by the device the gateway devices of information of determined active or standby status comprises:
transmitting, by the device, a notification message via each of interfaces connected to the gateway devices, to notify active or standby status of each of the interfaces.

5. The method according to claim 4, wherein the notification message is transmitted over a link layer protocol or a protocol over an Internet Protocol layer.

6. The method according to claim 4, further comprising:
configuring a common Internet Protocol address for interfaces, connected to the device, on the at least two gateway devices.

7. The method according to claim 4, further comprising:
publishing, by an active gateway device, route information of a high priority in the network, and publishing, by a standby gateway device, route information of a low priority in the network;
or
publishing, by the active gateway device, route information in the network.

8. The method according to claim 1, further comprising:
when one of the at least two gateway devices determines itself to be a standby gateway device and receives a packet destined for the device sent from the network, transmitting, by the standby gateway device, the packet to an active gateway device, sending, by the active gateway device, the packet to the device.

9. An apparatus for processing status of a gateway device, configured in a device, comprising:
a status determination unit, adapted for determining active or standby status of an interface via which the device is connected to the gateway device; and
a status notification unit, adapted for notifying the gateway device, connected to the device, of the determined active or standby status of the interface.

10. The apparatus according to claim 9, further comprising an interface detection unit, adapted for detecting working status of the interface via which the device is connected to the gateway device, and providing a result of the detection to the status determination unit.

11. The apparatus according to claim 9, further comprising a packet construction unit, adapted for constructing a notification message required by the status notification unit to notify the active or standby status of the interface.

12. A gateway device, comprising:
a status notification receiving unit, adapted for receiving active or standby status information of an interface from a device; and
a status adjustment unit, adapted for setting the gateway device into status corresponding to the active or standby status information of the interface.

13. The method according to claim 2, wherein notifying by the device the gateway devices of information of determined active or standby status comprises:
transmitting, by the device, a notification message via each of interfaces connected to the gateway devices, to notify active or standby status of each of the interfaces.

14. The method according to claim 13, wherein the notification message is transmitted over a link layer protocol or a protocol over an Internet Protocol layer.

15. The method according to claim 13, further comprising:
configuring a common Internet Protocol address for interfaces, connected to the device, on the at least two gateway devices.

16. The method according to claim 13, further comprising:
publishing, by an active gateway device, route information of a high priority in the network, and publishing, by a standby gateway device, route information of a low priority in the network; or
publishing, by the active gateway device, route information in the network.

17. The method according to claim 3, wherein notifying by the device the gateway devices of information of determined active or standby status comprises:
transmitting, by the device, a notification message via each of interfaces connected to the gateway devices, to notify active or standby status of each of the interfaces.

18. The method according to claim 17, wherein the notification message is transmitted over a link layer protocol or a protocol over an Internet Protocol layer.

19. The method according to claim 17, further comprising:
configuring a common Internet Protocol address for interfaces, connected to the device, on the at least two gateway devices.

20. The method according to claim 17, further comprising:
publishing, by an active gateway device, route information of a high priority in the network, and publishing, by a standby gateway device, route information of a low priority in the network; or
publishing, by the active gateway device, route information in the network.

21. The method according to claim 2, wherein determining by the device status of the gateway devices further comprises:
when the active gateway device has a fault, configuring the active gateway device to be a standby gateway device, and determining a new master gateway device.
